(19) United States
(12) Patent Application Publication
(10) Pub. No.: US 2010/0134372 A1
(43) Pub. Date: Jun. 3, 2010

(54) THZ-BAND FOLDED DIPOLE ANTENNA HAVING HIGH INPUT IMPEDANCE

(75) Inventors: Han Cheol Ryu, Gyeonggi-do (KR); Kwang Yong Kang, Daejeon (KR); Min Hwan Kwak, Daejeon (KR); Sung Il Kim, Seoul (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/498,870

(22) Filed: Jul. 7, 2009

(30) Foreign Application Priority Data
Dec. 3, 2008 (KR) 2008-0121920
Mar. 19, 2009 (KR) 2009-0023440

(51) Int. Cl. H01Q 9/16

(52) U.S. Cl. 343/793; 343/795

(57) ABSTRACT

Provided is a folded dipole antenna including a meander line formed on a photoconductive substrate, characterized by an input impedance of several kΩ, which is much higher than that of a conventional dipole antenna, due to optimization of a horizontal length, a line interval, a width, and a line number of the meander line. Accordingly, use of the folded dipole antenna greatly improves an impedance matching characteristic between the antenna and a photomixer having an output impedance of 10 kΩ or more, and accordingly an output of a THz continuous wave.

### CROSS-REFERENCE TO RELATED APPLICATION

This application claims priority to and the benefit of Korean Patent Application Nos. 10-2008-0121920, filed Dec. 3, 2008 and 10-2009-0023440, filed Mar. 19, 2009, the disclosure of which is incorporated herein by reference in its entirety.

### BACKGROUND

1. Field of the Invention

The present invention relates to a terahertz (THz)-band folded dipole antenna, and more particularly, to a folded dipole antenna having a high input impedance for improving an output of a THz continuous wave.

2. Discussion of Related Art

A terahertz (THz) wave is an electromagnetic wave at a frequency between infrared rays and microwaves in a range of 100 GHz to 10 THz. With recent developments in high technology, a THz wave has drawn attention as a future electromagnetic wave source, and is important in a variety of applications combining information technology (IT), bio technology (BT), etc.

In particular, since a THz wave is well transmitted through a variety of materials like an electromagnetic wave while going straight like light, it is expected to be widely utilized in basic sciences such as physics, chemistry, biology, medicine, etc, as well as general industries, national defense, security, etc., because the THz wave can be used to detect counterfeit notes, drugs, explosives, and chemical and biological weapons and to nondestructively examine industrial structures. Also, a THz-related scheme is expected to be widely used for wireless communication of 10 Gbit/s or more, high-speed data processing, and inter-satellite communication in information communications.

Many signal sources capable of generating a THz wave in pulse and continuous-wave forms have been studied. Among them, a photomixer has recently come into the spotlight. The photomixer can be manufactured in a size of a semiconductor chip, has excellent frequency variability, and operates at normal temperatures. Accordingly, the photomixer is being combined with an antenna and used to generate and detect a THz wave.

FIG. 1A illustrates a method for generating a THz continuous wave using a photomixer.

Referring to FIG. 1A, an antenna 130 and a photomixer 150 are formed on a low temperature grown (LGT)-GaAs substrate 110. When a laser beam having two different frequencies is input to the photomixer 150, optical current in a THz band corresponding to a difference between the two frequencies is generated due to a nonlinear characteristic of the photomixer 150.

In this case, the optical current generated by the photomixer 150 is coupled to the antenna and radiated in the form of an electromagnetic wave via the antenna 130, in which an output of the THz wave is changed due to a matching characteristic between the photomixer 150 and the antenna 130.

FIG. 1B is a diagram for explaining an impedance matching characteristic between the photomixer and the antenna shown in FIG. 1A.

Referring to FIG. 1B, the optical current i(ω,t) generated by the photomixer 150 is input to the antenna 130.

However, since the photomixer 150 has a very high output impedance R_{P} of 10 to 100 kΩ and the antenna 130 has a very low input impedance R_{A} of 100Ω or less, this causes severe impedance mismatching between the photomixer 150 and the antenna 130, such that the THz wave V_{B}(t) output from the antenna 130 generally has a low output of 1 μW or less.

Such impedance mismatching acts as large obstruction in application of THz waves. To resolve this problem, several antennas having high input impedances have been studied.

However, because these antennas have input impedances of merely hundreds of Ω, impedance mismatching between the antenna and the photomixer cannot be resolved.

### SUMMARY OF THE INVENTION

The present invention resolves impedance mismatching between a photomixer and an antenna. The present invention is directed to improving a matching characteristic between an antenna and a photomixer by implementing a folded dipole antenna having a high input impedance.

One aspect of the present invention provides a THz-band folded dipole antenna having a high input impedance, the antenna including: a meander line formed on a photoconductive substrate; and a photomixer coupled to a center of the meander line, wherein a horizontal length, a width, a line interval, and a line number of the meander line are determined so that an input impedance value of the meander line approaches an output impedance value of the photomixer.

Here, the photoconductive substrate may be a low temperature grown (LTG)-GaAs substrate or a photoconductive substrate having a carrier lifetime of tens of ps or less.

When the input impedance of the meander line has an imaginary part value of 0 and a real part value of a maximum value, the input impedance value of the meander line may approach an output impedance value of the photomixer.

Here, when the horizontal length of the meander line changes from a half wavelength band (0.4λ to 0 6λ) to one wavelength band (0.8λ to 1.0λ) of a resonance wavelength λ, the real part value of the input impedance of the meander line may increase and variation of the imaginary part value may increase and a bandwidth of the imaginary part value may decrease. Accordingly, the horizontal length of the meander line may be set to the half wavelength band (0.4λ to 0.6λ) of the resonance wavelength λ.

When the width of the meander line is greater than that of the photomixer, the real part value of the input impedance of the meander line may decrease. Accordingly, the width of the meander line may be the same as or smaller than that of the photomixer.

When the line interval of the meander line decreases, a maximum value of the real part of the input impedance of the meander line may increase and the imaginary part value of the input impedance may approach 0 at an operating frequency. In particular, when the line interval of the meander line ranges from 0.035λ to 0.045λ, the real part of the input impedance may have a maximum value and the imaginary part may have a value of 0 at the operating frequency. Accordingly, the line interval of the meander line may preferably range from 0.035λ to 0.045λ.

Finally, when the line number of the meander line increases from 3 to 11, the real part value of the input impedance of the meander line may increase, and when the line number is 11 or more, the input impedance value may be substantially the same. Accordingly, the line number of the meander line may be 11 or more.

Meanwhile, a surface current intensity of the meander line may decrease at locations away from a central portion to which the photomixer is coupled, and both ends of the meander line may have a minimum surface current intensity. Accordingly, a feed line for applying a voltage to the meander line may be connected to both ends of the meander line so as not to affect the radiation characteristic of the meander line.

Also, a radiation pattern of the meander line has a similar characteristic to a radiation pattern of a THz band dipole antenna.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1A illustrates a method for generating a THz continuous wave using a photomixer;

FIG. 1B is a diagram for explaining an impedance matching characteristic between a photomixer and an antenna shown in FIG. 1A;

FIG. 2 is a schematic diagram of a THz-band folded dipole antenna according to the present invention;

FIG. 3 illustrates an implementation of a THz-band folded dipole antenna according to the present invention;

FIGS. 4A and 4B are graphs illustrating a real part value Re(Z_{A}) of the antenna and an imaginary part value Im(Z_{A}) of an input impedance Z_{A} obtained through simulation while changing a horizontal length L and a line interval S of a meander line without a photoconductive substrate;

FIGS. 5A and 5B are graphs illustrating a real part value Re(Z_{A}) and an imaginary part value Im(Z_{A}) of an input impedance Z_{A} of the antenna having a horizontal length L of 0.5λ at 1 THz obtained through simulation while changing a line interval S of a meander line without a photoconductive substrate according to frequency;

FIG. 6 illustrates surface current distributions at a resonance frequency after forming a folded dipole antenna, a meander line of which has a horizontal length L of 0.5λ, a width W of 6 μm, a line interval S of 0.04λ, and a line number N of 3 without a photoconductive substrate;

FIGS. 7A and 7B are graphs illustrating a real part value Re(Z_{A}) and an imaginary part value Im(Z_{A}) of an input impedance Z_{A} obtained through simulation while changing a line interval S of a meander line after forming a folded dipole antenna, the meander line of which has a horizontal length L of 0.5λ, a width W of 6 μm, and a line number N of 3 on an LTG-GaAs substrate having a permittivity of 12.9 and a thickness of 350 μm;

FIG. 8 is a graph illustrating a real part value Re(Z_{A}) of an input impedance Z_{A} obtained through simulation while changing a line interval S of a meander line after forming a folded dipole antenna, the meander line of which has a horizontal length L of 0.5λ, a width W of 6.3 μm, and a line number N of 3 on an LTG-GaAs substrate having a permittivity of 12.9 and a thickness of 350 μm;

FIG. 9 is a graph illustrating a real part value Re(Z_{A}) of an input impedance Z_{A} obtained through simulation while increasing a line number N of a meander line after forming a folded dipole antenna, the meander line of which has a horizontal length L of 0.5λ, a width W of 6.3 μm, and a line number N of 3 on an LTG-GaAs substrate having a permittivity of 12.9 and a thickness of 350 μm;

FIG. 10 illustrates surface current distributions at a resonance frequency after forming a folded dipole antenna, a meander line of which has a horizontal length L of 0.5λ, a width W of 6 μm, a line interval S of 0.04λ, and a line number N of 11 on an LTG-GaAs substrate having a permittivity of 12.9 and a thickness of 350 μm;

FIGS. 11A and 11Bb illustrate radiation patterns of an E-plane and an H-plane after forming a folded dipole antenna, the meander line of which has a horizontal length L of 0.5λ, a width W of 6 μm, a line interval S of 0.04λ, and a line number N of 3 on an LTG-GaAs substrate having a permittivity of 12.9 and a thickness of 350 μm; and

FIGS. 12A and 12B illustrate radiation patterns of an E-plane and an H-plane after forming a folded dipole antenna, the meander line of which has a horizontal length L of 0.5λ, a width W of 6 μm, a line interval S of 0.04λ, and a line number N of 11 on an LTG-GaAs substrate having a permittivity of 12.9 and a thickness of 350 μm.

### DETAILED DESCRIPTION OF EXEMPLARY EMBODIMENTS

Hereinafter, a THz-band folded dipole antenna having a high input impedance according to the present invention will be described in detail with reference to the accompanying drawings. However, the present invention is not limited to the embodiments disclosed below, but can be implemented in various forms. Therefore, the following embodiments are described in order for this disclosure to be complete and enabling to those of ordinary skill in the art.

FIG. 2 is a schematic diagram of a THz-band folded dipole antenna 200 according to the present invention.

Referring to FIG. 2, the folded dipole antenna 200 according to the present invention includes a meander line 230 formed on a photoconductive substrate 210.

Here, the photoconductive substrate 210 may be a photoconductive substrate having a carrier lifetime of tens of ps or less or a low temperature grown (LTG)-GaAs substrate.

The meander line 230 is a continuation of folded strips 231, and is vertically symmetrical with respect to its center.

A photomixer 250 is coupled to the center of the meander line 230, and a feed line (not shown) for applying a voltage is connected between both ends of the meander line 230.

A horizontal length L, a width W, a line interval S, and a line number N of the meander line 230 may be adjusted. Here, the horizontal length L indicates a length at which the meander line 230 is laid horizontally along (or in parallel with) the photoconductive substrate 210 lengthwise.

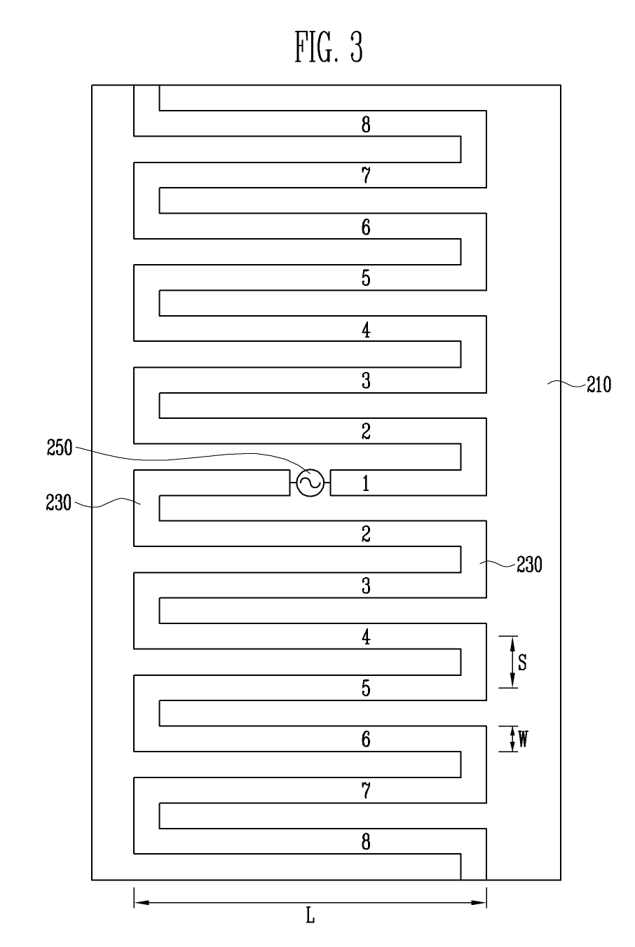

FIG. 3 illustrates an implementation of the THz-band folded dipole antenna 200 according to the present invention, the meander line 230 of which has a horizontal length L of 0.5λ, a width W of 6.3 μm, a line interval S of 9.15 μm, and a line number N of 15.

The folded dipole antenna 200 according to the present invention is characterized by a much higher input impedance than that of a conventional folded dipole antenna due to optimization of the horizontal length L, the line interval S, the width W, and the line number N of the meander line 230, which will now be described in greater detail.

First, influence of the horizontal length L and the line interval S of the meander line 230 on the input impedance will be described.

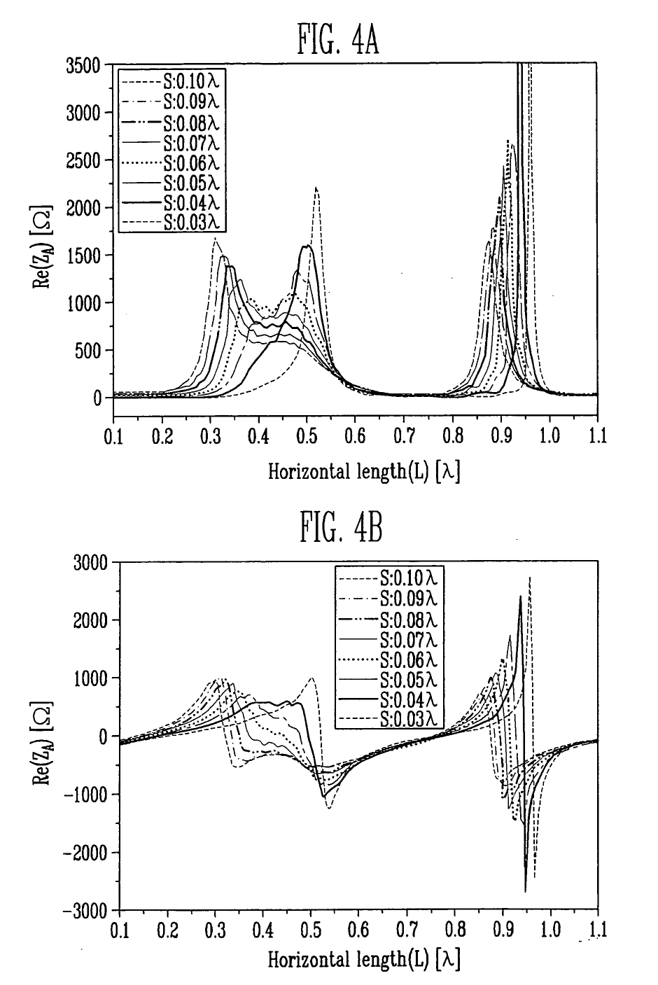

FIGS. 4A and 4B are graphs illustrating a real part value Re(Z_{A}) and an imaginary part value Im(Z_{A}) of an input impedance Z_{A} obtained through simulation while changing the horizontal length L and the line interval S of the meander line 230 without a photoconductive substrate. Here, the width W of the meander line 230 was fixed to 6 μm, which is similar to a size of the photomixer, and the line number N was fixed to a minimum value, 3. It is assumed that the meander line 230 was disposed in a free space without a photoconductive substrate in order to observe only a unique characteristic of the folded dipole antenna.

Referring to FIG. 4A, the real part of the input impedance in a 0.8λ to 1.0 area, in which the horizontal length L of the meander line 230 corresponds to one resonance wavelength λ, has a greater maximum value than that of a real part of the input impedance in a 0.4λ˜0.6λ area, which corresponds to the half of the resonance wavelength λ. However, referring to FIG. 4B, a bandwidth in the one wavelength area is smaller than that in the half wavelength area, and the imaginary part value of the input impedance has large variation.

Accordingly, the horizontal length L of the meander line 230 may be set in a range of 0.4λ to 0.6λ, and particularly, 0.5λ, for stable operation of the folded dipole antenna.

As shown in FIGS. 4A and 4B, although the maximum value of the real part of the input impedance increases when the line interval S of the meander line 230 in the folded dipole antenna decreases, the line interval S of the meander line 230 may be set to 0.04λ or more in consideration of manufacturing limitations, operation stability, and bandwidth of the antenna.

A notable result of this simulation result is that when the imaginary part of the input impedance of the folded dipole antenna has a value of 0, the real part has a maximum value. This means that when all power input from the photomixer 250 is radiated from the folded dipole antenna 200, an input impedance value of the folded dipole antenna 200 most closely approaches an output impedance value of the photomixer 250, leading to increased impedance matching efficiency between the photomixer 250 and the folded dipole antenna 200.

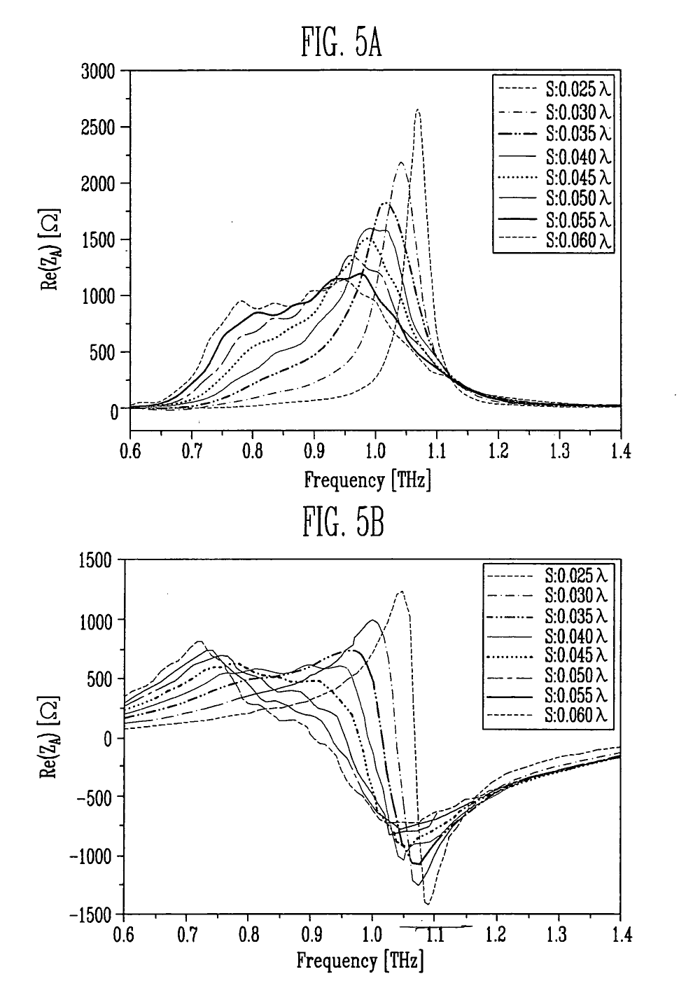

FIGS. 5A and 5B are graphs illustrating a real part value Re(Z_{A}) and an imaginary part value Im(Z_{A}) of an input impedance Z_{A} obtained through simulation while changing the line interval S of the meander line 230 without a photoconductive substrate, in which the horizontal length L of the meander line 230 was fixed to 0.5λ at 1 THz, the width W was fixed to 6 μm, similar to the size of the photomixer, and the line number N was fixed to a minimum value, 3.

Here, the horizontal length L of the meander line 230 was fixed to 0.5λ at 1 THz for the antenna to operate in a 400 GHz band when the antenna is formed on an LTG-GaAs substrate 210 having a permittivity of 12.9.

Referring to FIGS. 5A and 5B, it can be seen that when the line interval S of the meander line 230 decreases from 0.06λ to 0.025λ, the maximum value of the real part of the input impedance increases and the bandwidth decreases, and the imaginary part value of the input impedance approaches a value of 0 at an operating frequency.

In particular, since the real part of the input impedance is the maximum value and the imaginary part value is 0 at an operating frequency of about 1 THz when the line interval S of the meander line 230 ranges from 0.035λ to 0.045λ, the line interval S of the meander line 230 preferably ranges from 0.035λ to 0.045λ.

Referring to FIG. 5B, it can be seen that when the line interval S of the meander line 230 is 0.04λ, the imaginary part value of the input impedance has a value of 0 in a 1 THz area, which means that all power input from the photomixer 250 is radiated through the folded dipole antenna 200. Accordingly, the line interval S of the meander line 230 preferably is set to 0.04λ in consideration of operational stability and bandwidth in the 1 THz area.

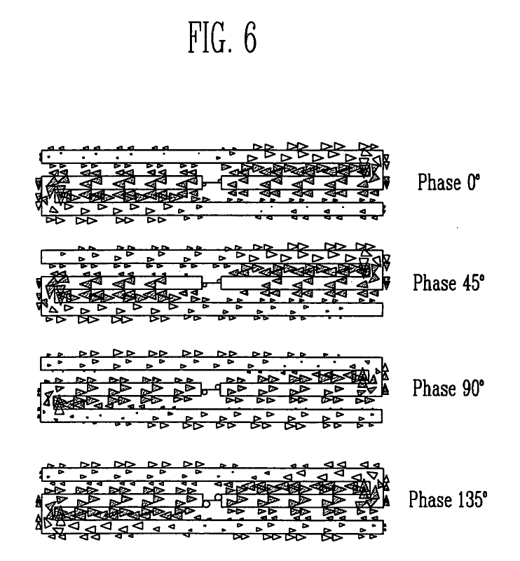

FIG. 6 illustrates surface current distributions at a resonance frequency after forming a folded dipole antenna, the meander line 230 of which has a horizontal length L of 0.5λ, a width W of 6 μm, a line interval S of 0.04λ, and a line number N of 3 without a photoconductive substrate.

Referring to FIG. 6, it can be seen that surface current distributions of the meander line 230 in the folded dipole antenna 200 of the present exemplary embodiment differ among areas and, in particular, current intensity rapidly decreases at locations away from the photomixer 250 located at the center.

In other words, it can be seen that a general assumption that a conventional half-wavelength folded dipole antenna has the same current distribution as a half-wavelength dipole antenna is not applied to the folded dipole antenna of the present exemplary embodiment.

The characteristic of the folded dipole antenna formed without a photoconductive substrate has been described. A characteristic of a folded dipole antenna formed on a photoconductive substrate will now be described.

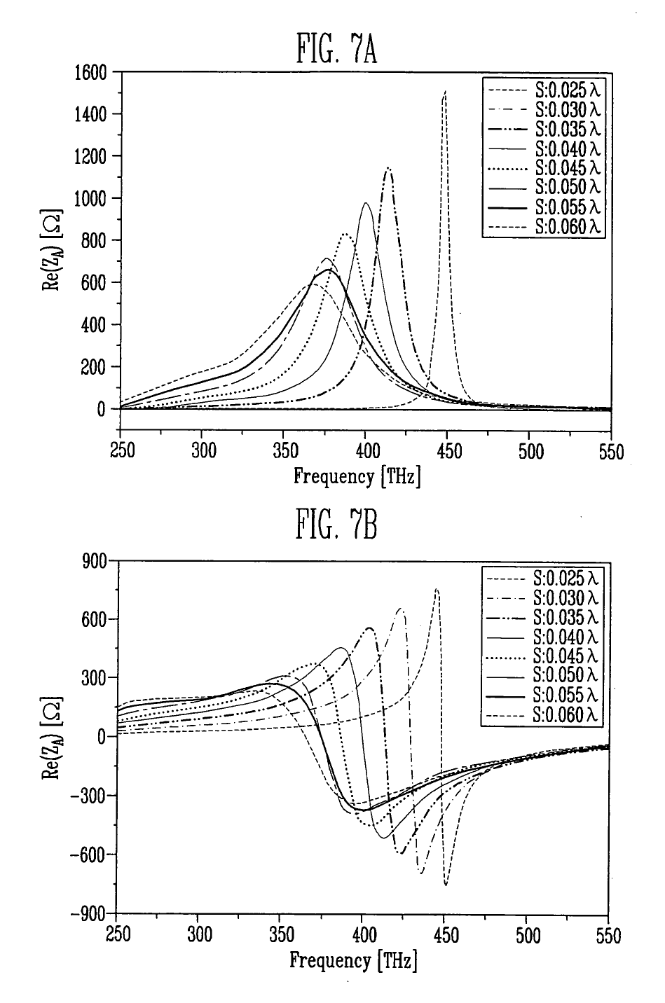

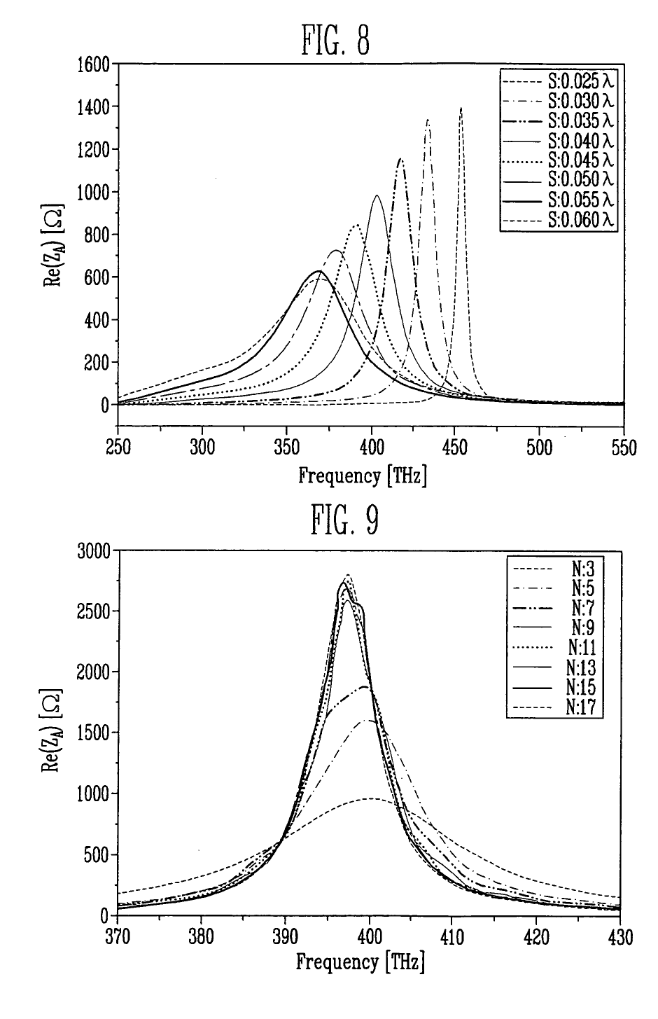

FIGS. 7A and 7B are graphs illustrating a real part value Re(Z_{A}) and an imaginary part value Im(Z_{A}) of an input impedance Z_{A} obtained through simulation while changing the line interval S of the meander line 230 after forming a folded dipole antenna, the meander line 230 of which has a horizontal length L of 0.5λ, a width W of 6 μm, and a line number N of 3 on an LTG-GaAs substrate having a permittivity of 12.9 and a thickness of 350 μm, in which a wavelength was fixed to 1 THz, as in the foregoing example.

Referring to FIGS. 7A and 7B, it can be seen that the input impedance of the folded dipole antenna formed on the photoconductive substrate is similar in form to that of the folded dipole antenna formed without the photoconductive substrate (see FIGS. 5A and 5B), but the operating frequency band is shifted from 1 THz to 400 GHz and the bandwidth decreases, as expected.

Also, as described above, it can be seen that when the line interval S of the meander line 230 is 0.04λ, the imaginary part of the input impedance has a value of 0 and the real part has a maximum value in a 400 GHz area, which means that the impedance matching efficiency between the photomixer 250 and the folded dipole antenna 200 is highest and the radiation characteristic of the folded dipole antenna 200 is best.

Next, influence of the width W of the meander line 230 and the line number N on the input impedance will be described.

FIG. 8 is a graph illustrating a real part value Re(Z_{A}) of an input impedance Z_{A} obtained through simulation while changing the line interval S of the meander line 230 after forming a folded dipole antenna, the meander line 230 of which has a horizontal length L of 0.5λ, a width W of 6.3 μm, and a line number N of 3 on an LTG-GaAs substrate having a permittivity of 12.9 and a thickness of 350 μm. A simulation condition in FIG. 8 is the same as that in FIG. 7a except that the width W of the meander line 230 increases from 6 μm to 6.3 μm.

Referring to FIG. 8, when the width W of the meander line 230 increases, it can be seen that, unlike the case shown in FIG. 7a, the real part value Re(Z_{A}) of the input impedance decreases and only the operating frequency increases somewhat.

In other words, when the width W of the meander line 230 becomes greater than that of the photomixer 250, the input impedance of the antenna decreases. Accordingly, the width W of the meander line 230 may preferably be the same as or smaller than that of the photomixer 250.

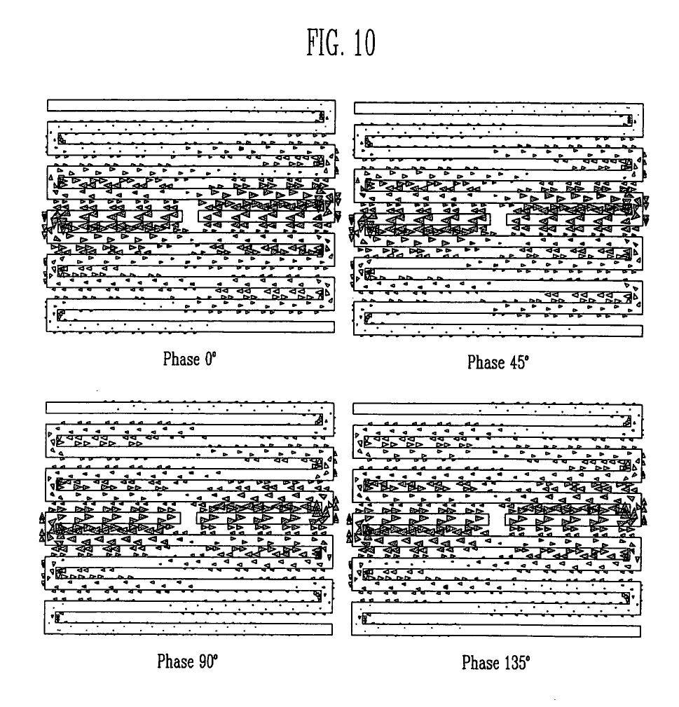

FIG. 9 is a graph illustrating a real part value Re(Z_{A}) of an input impedance Z_{A} obtained through simulation while increasing the line number N of the meander line 230 after forming a folded dipole antenna, the meander line 230 of which has a horizontal length L of 0.5λ, a width W of 6.3 μm, and a line number N of 3 on an LTG-GaAs substrate having a permittivity of 12.9 and a thickness of 350 μm.

Referring to FIG. 9, it can be seen that when the line number N of the meander line 230 increases, the real part value of the input impedance increases to about 1 to 3 kΩ, and when the line number N of the meander line 230 is 11 or more, the input impedance value is substantially the same.

That is, the folded dipole antenna 200 of the present exemplary embodiment has an input impedance value about 30 times greater than an input impedance of hundreds of Ω of a typical antenna, such that an impedance matching characteristic between the antenna and the photomixer 250 having an output impedance of 10 kΩ or more is greatly enhanced.

Since the input impedance value is substantially the same when the line number N of the meander line 230 is 11 or more, a feed line (not shown) connected to a last line for applying a voltage does not greatly affect the radiation characteristic of the antenna.

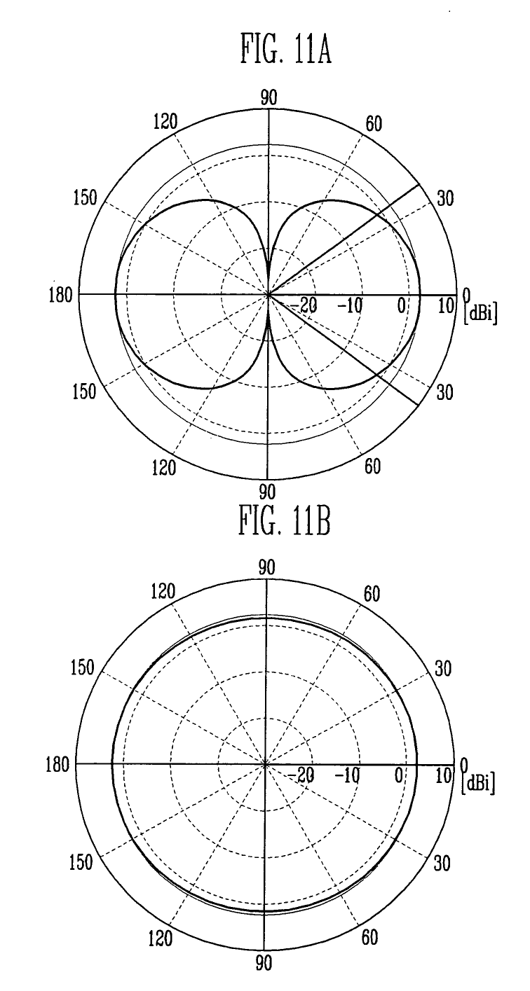

FIG. 10 illustrates surface current distributions at a resonance frequency after forming a folded dipole antenna the meander line 230 of which has a horizontal length L of 0.5λ, a width W of 6 μm, a line interval S of 0.04λ, and a line number N of 11 on an LTG-GaAs substrate having a permittivity of 12.9 and a thickness of 350 μm.

Referring to FIG. 10, the surface current distributions of the meander line 230 in the folded dipole antenna 200 of the present exemplary embodiment differ among areas. In particular, the intensity of the surface current rapidly decreases at locations away from the photomixer 250 located at the center.

Accordingly, it can be seen that a feed line (not shown) connected to both ends of the meander line 230 having a very small surface current intensity for applying a voltage does not greatly affect the antenna characteristic.

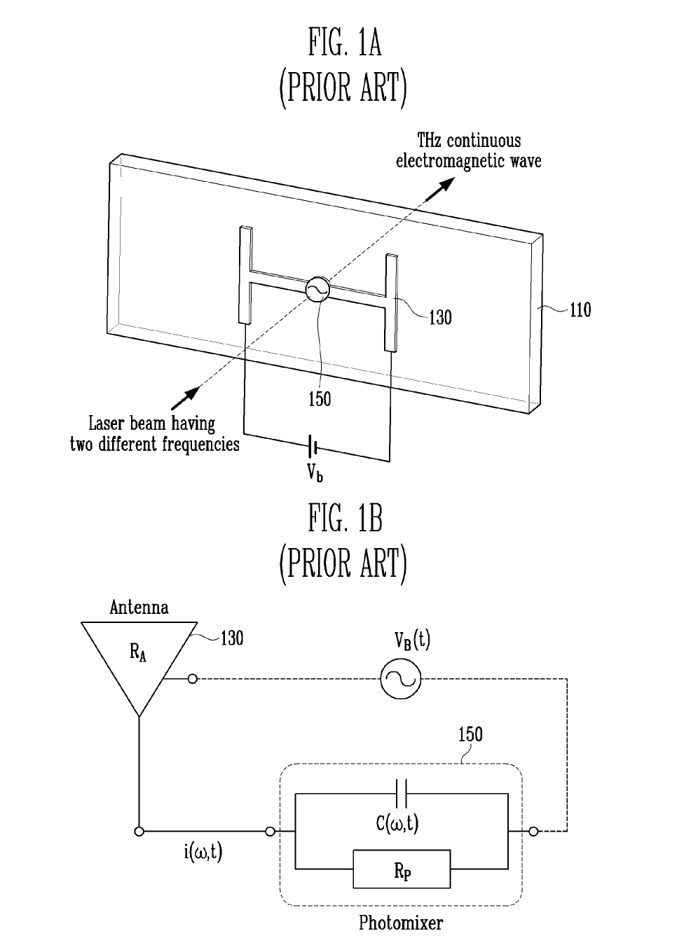

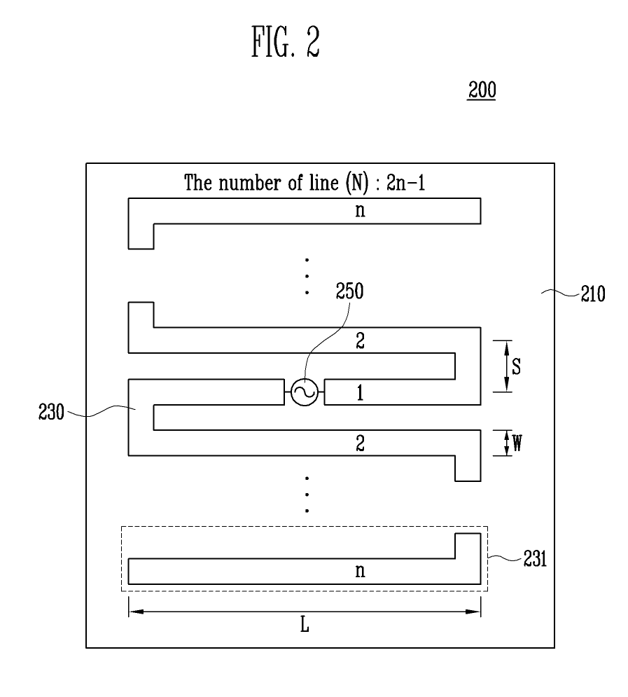

FIGS. 1A and 1B illustrate radiation patterns of an E-plane and an H-plane after forming a folded dipole antenna 200, the meander line 230 of which has a horizontal length L of 0.5λ, a width W of 6 μm, a line interval S of 0.04λ, and a line number N of 3 on an LTG-GaAs substrate having a permittivity of 12.9 and a thickness of 350 μm.

Referring to FIGS. 11A and 11B, it can be seen that the folded dipole antenna of the present exemplary embodiment has directivity of 2.6 dBi, a 3 dB beam width of an electric field plane of 74.7°, and no 3 dB beam width of a magnetic field plane.

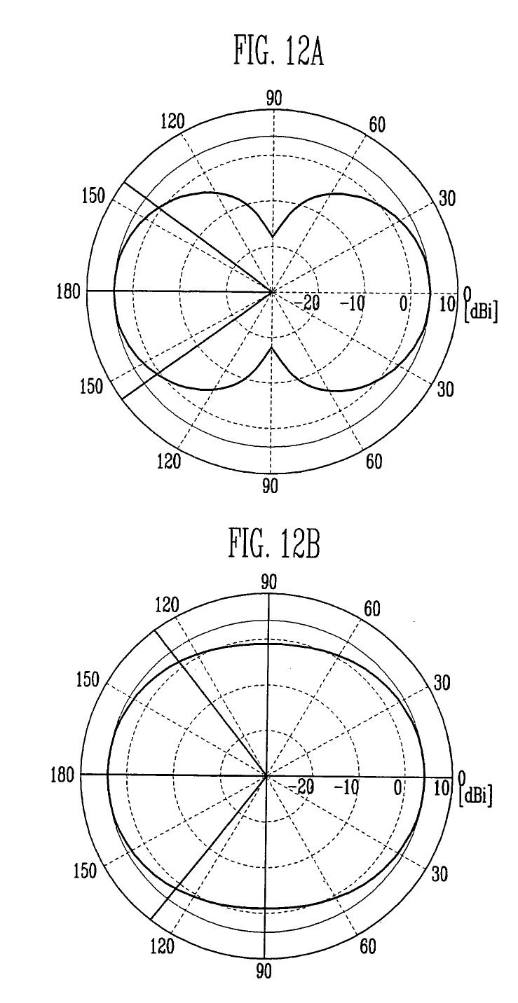

FIGS. 12A and 12B illustrate radiation patterns of an E-plane and an H-plane after forming a folded dipole antenna 200, the meander line 230 of which has a horizontal length L of 0.5λ, a width W of 6 μm, a line interval S of 0.04λ, and a line number N of 11 on an LTG-GaAs substrate having a permittivity of 12.9 and a thickness of 350 μm.

Referring to FIGS. 12A and 12B, it can be seen that the folded dipole antenna of the present exemplary embodiment has directivity of 4.2 dBi, a 3 dB beam width of an electric field plane of 73°, and a 3 dB beam width of a magnetic field plane of 104.4°.

That is, the folded dipole antenna 200 of the present invention has a radiation pattern with directivity increasing with the line number N of the meander line 230, unlike a typical dipole antenna having directivity of 2.2 dBi, a 3 dB beam width of an electric field plane of 78.8°, and no 3 dB beam width of a magnetic field plane. However, the radiation pattern is suitable for a THz band antenna because it is similar to that of the typical dipole antenna.

As a result, the folded dipole antenna 200 according to the present invention has a very high input impedance, which greatly improves the impedance matching characteristic with the photomixer 250 for THz wave generation, thereby greatly improving the THz output.

Although the folded dipole antenna 200 according to the present invention has been described as generating the continuous THz wave, it may be applied to a system for generating a pulsed THz wave using a femtosecond laser.

A folded dipole antenna according to the present invention has an input impedance of several kΩ, which is much higher than that of a conventional dipole antenna, due to optimization of a horizontal length, a line interval, a width, and a line number of a meander line. Thereby a matching characteristic between the antenna and a photomixer, and accordingly an output of a THz continuous wave, can be greatly improved.

Also, in the folded dipole antenna according to the present invention, a feed line for applying a voltage is connected between both ends of the meander line having a very small surface current intensity, thereby reducing influence of the feed line on an antenna characteristic.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A terahertz (THz)-band folded dipole antenna having a high input impedance, the antenna comprising:
a meander line formed on a photoconductive substrate; and
a photomixer coupled to a center of the meander line,
wherein a horizontal length, a width, a line interval, and a line number of the meander line are determined so that an input impedance value of the meander line approaches an output impedance value of the photomixer.

2. The antenna of claim 1, wherein when the input impedance of the meander line has an imaginary part value of 0 and a real part value of a maximum value, the input impedance value of the meander line approaches the output impedance value of the photomixer.

3. The antenna of claim 2, wherein when the horizontal length of the meander line changes from a half wavelength band (0.4λ to 0.6λ) to one wavelength band (0.8λ to 1.0λ) of a resonance wavelength λ, the real part value of the input impedance of the meander line increases and variation of the imaginary part value increases and a bandwidth of the imaginary part value decreases.

4. The antenna of claim 3, wherein the horizontal length of the meander line is set to the half wavelength band (0.4λ to 0.6λ) of the resonance wavelength λ.

5. The antenna of claim 2, wherein when the width of the meander line is greater than that of the photomixer, the real part value of the input impedance of the meander line decreases.

6. The antenna of claim 5, wherein the width of the meander line is the same as or smaller than that of the photomixer.

7. The antenna of claim 2, wherein when the line interval of the meander line decreases, a maximum value of the real part of the input impedance of the meander line increases and the bandwidth of the real part of the input impedance of the meander line decreases and the imaginary part value of the input impedance approaches 0 at an operating frequency.

8. The antenna of claim 7, wherein when the line interval of the meander line ranges from 0.035λ to 0.045λ, the real part of the input impedance has a maximum value and the imaginary part has a value of 0 at the operating frequency.

9. The antenna of claim 2, wherein when the line number of the meander line increases from 3 to 11, the real part value of the input impedance of the meander line increases, and when the line number is 11 or more, the input impedance value is substantially the same.

10. The antenna of claim 9, wherein the line number of the meander line is 11 or more.

11. The antenna of claim 1, wherein a surface current intensity of the meander line decreases at locations away from a central portion to which the photomixer is coupled, and both ends of the meander line have a minimum surface current intensity.

12. The antenna of claim 11, wherein a feed line for applying a voltage to the meander line is connected to both ends of the meander line so as not to affect the radiation characteristic of the meander line.

13. The antenna of claim 1, wherein a radiation pattern of the meander line has a similar characteristic to a radiation pattern of a THz band dipole antenna.

14. The antenna of claim 1, wherein the photoconductive substrate is a low temperature grown (LTG)-GaAs substrate or a photoconductive substrate having a carrier lifetime of tens of ps or less.
